(19) United States
(12) Patent Application Publication
(10) Pub. No.: US 2008/0169283 A1
(43) Pub. Date: Jul. 17, 2008

(54) Microwave Oven With at Least One Match Plate

(75) Inventors: Gerard Beausse, Charenton (FR); Michel Foray, Passenans (FR)

Correspondence Address: THOMPSON HINE LLP;Intellectual Property Group, P.O Box 8801, DAYTON, OH, 45401-8801, US

(73) Assignee: PREMARK FEG L.L.C., Wilmington, DE (US)

(21) Appl. No.: 11/911,538

(22) PCT Filed: Apr. 10, 2006
(86) PCT No.: PCT/US06/13186

§ 371 Date: Oct. 15, 2007

(30) Foreign Application Priority Data
Apr. 22, 2005 (FR) 0504051
Apr. 10, 2006 (US) PCT/US2006/013186

(51) Int. Cl. H05B 6/80

(52) U.S. Cl. 219/725

(57) ABSTRACT

The microwave oven of the invention comprises a food-cooking cavity, microwave-generating means, at least one microwave adapter plate (34), at least one plate support (17) mounted removably on a cavity wall, characterised in that the adapter plate (34) is fixed to the plate support (17).

Thus there is a simple and inexpensive system allowing easy cleaning of the cavity walls and of the adapter plate or plates, while not impairing proper positioning and operation of the latter.

The invention concerns the field of microwave ovens, in particular so-called large-scale professional catering ovens, that is, large-capacity ovens (typically over 0.15 m³).

In the fields of restaurants, canteens, refectories, etc., large-scale catering ovens are used.

There are several types of large-scale catering ovens. Convection-heated ovens comprise, inside the oven cavity, a gas burner or one or more heating resistors and one or more convection fans. In steam-heated ovens, the steam is produced either indirectly outside the cavity or directly by spraying water onto a fan associated with a heating resistor or a gas burner. Some ovens are the combination type, with convection and steam heating, to improve their performance.

The recent development of large-scale catering ovens has led to the integration, in addition to one or both heating means presented above, of a microwave heating means.

International patent application WO 2004/032570, for example, has an oven with microwave heating means. In this oven, at least one microwave-generating means, in this case a magnetron, is provided outside the oven cavity, and supplies a microwave agitation enclosure. This enclosure is opposite an opening in a side wall of the oven cavity, which is covered by a protective, microwave-permeable glass panel. In the cavity, opposite the microwave agitation enclosure, is fixed a microwave adapter or coupling plate. Such a plate is better known by its English name “match plate”.

Two adapter plates may be placed in the oven cavity, preferably opposite each other. These adapter plates are generally in the form of a rectangular metal plate, in which suitable apertures are made.

The functions of the adapter plates are in particular to couple the microwave resonance modes and thus favour making them resonate, to distribute the microwaves in the cavity and make them uniform, serving as an aerial and deflector. Furthermore, such a mode of generation and distribution of microwaves enables the use of metal in the microwave oven cavity, which is preferable, in particular in large-scale catering applications.

In order to fulfil its role correctly, each adapter plate must be fixed in a perfectly parallel and rigid manner to the wall close to which it extends. This fixing is obtained by welding, to the wall in question, of feet integral with the plate, performing a function of fixing but also as a strut, in order to adjust the distance separating the wall from the plate.

The use of an oven results in the deposition, in all areas of its cavity, of food residues, fat, carbonisation products, etc. This is even more so in the case of a combination oven, with convection and/or steam heating means, since convection and steam transport suspensions into all recesses of the oven. Thus, the facing surfaces of the wall and the adapter plate adjoining it are liable to be soiled. It is very difficult to access them for cleaning them, the space between these two components being generally of the order of a few centimetres.

In order to make up for this drawback, mounting the adapter plate removably on its supporting wall may be envisaged. However, this gives rise to increased cost and complexity of the attachment systems. Closing the space between the plate and the wall may also be envisaged. Such a solution has the drawback of preventing air circulation, which impairs the output of the oven, or even proper operation thereof.

The present invention proposes a simple and inexpensive system aiming to allow easy cleaning of the cavity walls and of the adapter plate or plates, while not impairing proper positioning and operation of the latter.

Thus the invention concerns a microwave oven, comprising a food-cooking cavity, microwave-generating means, at least one microwave adapter plate, at least one plate support mounted removably on a cavity wall, characterised in that the adapter plate is fixed to the plate support.

The invention applies to any microwave-heated oven, comprising at least one plate support. It applies particularly well to large-scale catering ovens.

The invention will be better understood with the aid of the following description of the preferred embodiment of the oven of the invention, with reference to the attached drawings in which:

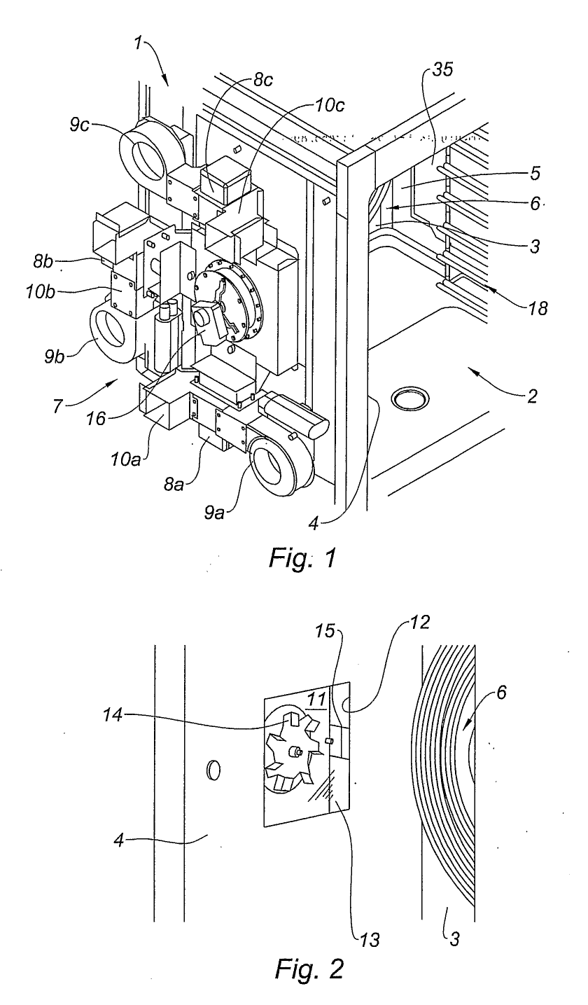

FIG. 1 shows a partial schematic perspective view of the preferred embodiment of the oven of the invention, seen from the outside of the left side;

FIG. 2 shows a partial schematic perspective view of the left side wall of the preferred embodiment of the oven of the invention, seen from the inside on the right;

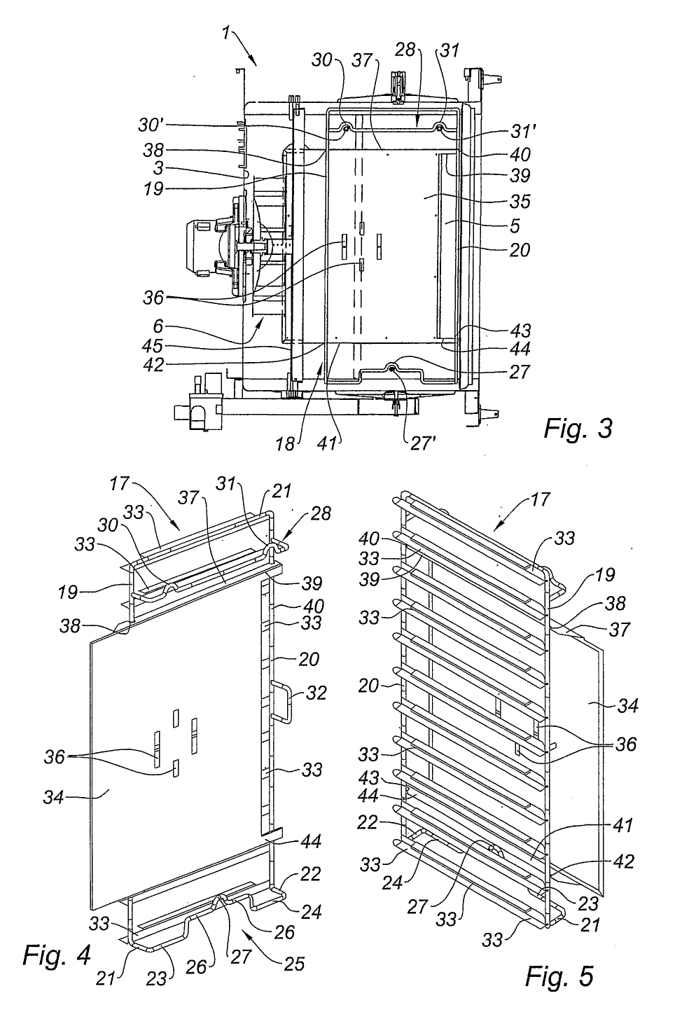

FIG. 3 shows a partial schematic view in section of the right side wall of the preferred embodiment of the oven of the invention, seen from the left;

FIG. 4 shows a schematic perspective view of a plate support and an adapter plate of the preferred embodiment of the oven of the invention, seen from the rear; and

FIG. 5 shows a schematic perspective view of a plate support and an adapter plate of the preferred embodiment of the oven of the invention, seen from the front.

With reference to FIG. 1, the microwave oven 1 described here is a large-scale catering oven. It comprises a cooking or heating cavity 2 for foodstuffs. This cavity 2 is formed by a back wall 3 and two side walls 4, 5, a left wall 4 and a right wall 5 in a view from the front, as well as a roof and a floor, and opens towards the front. A door, not shown, is provided for closing the cavity 2 on its front face during operation of the oven 1. The cavity 2 here forms a volume of at least 0.15 m³.

The oven 1 is here a combination oven, comprising in this case steam heating means, not shown, convection heating means 6, and microwave-generating means 7 for heating by microwaves. The steam heating means comprise in this case an external boiler supplying the interior of the oven with steam, in a known manner. The convection heating means 6 here comprise a heating resistor combined with a convection fan, placed on the back wall 3 of the cavity 2; any other convection heating means may be envisaged, for example, a burner combined with a fan.

The microwave-generating means 7 here include three magnetrons 8a, 8b, 8c fixed on the outside of the left wall 4 of the oven 1, each associated with cooling means comprising a fan 9a, 9b, 9c and an air discharge conduit 10a, 10b, 10c respectively, well known to anyone skilled in the art. The magnetrons 8a, 8b, 8c emit microwaves in waveguides, which open out, with reference to FIG. 2, into a microwave agitation enclosure 11. In FIG. 2 can be seen the orifice opening out from a waveguide 15 into the enclosure 11. This wave agitation enclosure 11 opens on to the cavity 2 of the oven 1, opposite this cavity 2, at the level of an opening 12 in the inner surface of the left wall 4 of the oven 1. The wave agitation enclosure 11 is in fact formed in the thickness of the left side wall 4 of the oven 1. This opening 12 is covered by a protective, microwave-permeable glass panel 13. In the enclosure 11 is mounted a rotor 14 for reflection and agitation of the microwaves, comprising adapted fins and blades, well known to anyone skilled in the art, an embodiment of which is precisely described in application WO 2004/032570 cited above. This rotor 14 is driven by a motor 16 placed outside the oven 1.

Thus, the microwaves generated by the magnetrons are agitated in the wave agitation enclosure 11 and dispersed in the cavity 2 of the oven 1 via the opening 12 in the inner surface of its left wall 4.

The oven 1 comprises, on each of its side walls 4, 5, a plate support 17, 18 respectively, mounted on the wall 4, 5 removably. Only the support 17 designed to be mounted on the left wall 4 will be described, with reference to FIGS. 4 and 5, the two supports 17, 18 being symmetrical in relation to each other (in relation to a vertical plane perpendicular to the back wall 3, when they are mounted). The same references will be used for the two supports 17, 18, as well as the means of the walls 4, 5 of the oven 1 which cooperate with them. The support 18 placed on the right side of the cavity 2 can be seen in FIGS. 1 and 3.

In the continuation of the description, “internal” or “external” means internal or external in relation to the centre of the oven cavity when the support 17 is mounted. “Front” or “rear” means front or rear in relation to the cavity, the front being on the open side of the cavity 2.

The support 17 is in the form of a ladder. It comprises a generally rectangular upright, comprising two bars or two tubes which are vertical 19, 20 connected at their top by a horizontal bar or tube 21. Each vertical bar 19, 20 is extended, at its bottom end, by a portion 21, 22 respectively extending towards the outside, at right angles with the corresponding bar 19, 20, and which is extended in a horizontal portion 23, 24, at right angles with the above portion 21, 22. These two horizontal portions 23, 24 meet at a fixing portion 25; this fixing portion 25 is in the form of an arch with right angles formed from the horizontal portions 23, 24, and which stands in a vertical plane. The horizontal bar 26 of this arch comprises, in its central portion, a fixing means 27, here shaped in the form of a curved arc portion 27 extending upwards, designed to cooperate, with reference to FIG. 3, with a fixing means 27′ integral with the wall, in this case a dowel 27′.

Furthermore, near its upper end, the plate support 17 comprises, integral with its two vertical bars 19, 20, a fixing arch 28 extending outwards in a horizontal plane, of which the outer bar 29, parallel to the upper bar 21 of the support 17, comprises, near each of its lateral ends, fixing means 30, 31, here too each shaped in the form of a curved arc portion 30, 31 extending upwards, designed to cooperate, with reference to FIG. 3, with a fixing means 30′, 31′ integral with the wall 4, in this case a dowel 30′, 31′.

The plate support 17 also comprises, on its front vertical bar 20—namely, for the left support 17, on the left bar 20 in the front view of FIG. 5—a positioning arch 32. This arch 32 extends rearwards in a vertical plane perpendicular to the plane including the two vertical bars 19, 20 of the plate support 17. It is designed to bear on a positioning element integral with the wall 4, not shown, for better positioning of the support 17.

Thus the plate support 17 here comprises two fixing means 30, 31 in the upper position, a fixing means 27 in the lower position, designed to cooperate with fixing means 30′, 31′, 27′ respectively, integral with the wall 4 to which the support 17 is fixed. This fixing is removable, which makes it possible to detach the plate supports 17, 18 for cleaning them, for example. It goes without saying that other configurations and structures may be provided for the means for removably fixing the support 17 to the wall 4. The support 17 optionally comprises additional means 32 for positioning relative to the wall 4.

The plate support 17 comprises, transversely to its vertical bars 19, 20, a plurality of crossbars 33 forming guides and plate supports. The plate support 17 therefore has a ladder structure. These crossbars 33 are arranged on the inside of the plate support 17. The crossbars 33 of one plate support 17 are opposite the crossbars 33 of the other plate support 18. They are arranged so as to guide a plate in the cavity 2 of the oven 1 and support it in a horizontal position. This type of crossbars 33 for guides and plate supports is well known to anyone skilled in the art, and so a description of them will not be detailed below.

The oven 1 also comprises at least one adapter plate, here two adapter plates 34, 35. These adapter plates 34, 35 have the function of distributing the microwaves from the microwave agitation enclosure 11 in the cavity 2 and making them uniform. They play a role of deflector and aerial, and cause resonance of the microwaves. They are adapted to the various wave resonance modes, in a manner known to anyone skilled in the art.

Again here will be described, with reference to FIGS. 4 and 5, the adapter plate 34 designed to extend on the left side of the cavity 2, the other plate 35, which can be seen in FIGS. 1 and 3, being symmetrical to it in the same way as above. The same references will be used for the two plates 34, 35.

The adapter plate 34 is in the form of a rectangular metal plate, comprising in its central portion a plurality of apertures 36. These apertures 36 are dimensioned by the expert according to the number of magnetrons 8a, 8b, 8c and the wavelengths emitted. Here they are of rectangular shape. They make it possible to let through certain microwaves of certain particular wavelengths, which are directly transmitted in the direction of the apertures 36 of the other plate 35, in order then to be reflected on the wall 5 of the cavity 2. Each plate 34, 35 also behaves as an aerial and a deflector. Its dimensions depend on the application, and are well known to anyone skilled in the art. A detailed description of it is not necessary here.

Each adapter plate 34, 35 is here fixed integrally to the plate support 17, 18 located near the wall 4, 5 close to which it is to extend. Operation of the microwave oven 1 requires the placement of each plate 34, 35 parallel to a wall 4, 5, at a given distance from the latter. Each adapter plate 34, 35 extends between the corresponding plate support 17, 18 and wall 4, 5. The prior art instructed adjusting the strut between the plate and its fixing wall by the dimension of its fixing feet. Within the scope of the invention, this strut is adjusted indirectly by the distance of the plate 34, 35 from the plate support 17, 18 to which it is fixed, and by the distance between said plate support 17, 18 and the wall 4, 5 to which it is fixed removably. Thus the distance between an adapter plate 34, 35 and a wall 4, 5 is adjusted, and possibly readjusted, either by its distance from the plate support 17, 18 or by the distance from the plate support 17, 18 to the wall 4, 5 and, in any case, by a combination of these two distances.

The adapter plate 34 comprises, on its upper edge, a clamp 37 projecting inwards perpendicularly to the plane of the plate 34. This clamp 37 does not extend as far as the rear end of the plate 34. In fact, as we shall see later, the adapter plates are not centred relative to the plate support 17, 18 to which they are fixed. It comprises, near its rear end, an indentation 38 of which the shape mates with the shape of the outer surface of the rear vertical bar 19. This indentation 38 forms a means 38 for fixing to the plate support 17. The adapter plate 34 is welded to the plate support 17 along the contact surface between the indentation 38 and the rear vertical bar 19.

At its front end, the clamp 37 is extended, outside the surface of the plate 34 and forwards, by a foot 39 which at its front end comprises an indentation 40 forming a means 40 for fixing to the front vertical bar 20. In the same way as above, the foot 39 is welded to the vertical bar 20 along the contact surface of the indentation 40 with this bar 20.

In a fully comparable manner, the adapter plate 34 comprises on its lower edge a clamp 41 comprising means 42, 43 for fixing to the vertical bars 19, 20 respectively, in this case indentations 42, 43 along which the plate 35 is welded to the bars 19, 20. In the same way, the fixing means 43 situated at the front is carried by a foot 44 extending outside the surface of the plate 34 forwardly, the plate 34 being therefore set rearwardly off centre relative to the plate support 17.

The adapter plate 34 may also comprise positioning means 46. In this case these are an orifice 46 formed in the plate 34 and designed to cooperate with a dowel 47 for positioning the plate support 17. This positioning means 46 makes it possible to ensure proper positioning of the plate 34 relative to its support 17 and thus ensure that the fixing means 38, 40, 42, 43 are rigidly connected to the support 17 in the proper place.

The description which has been given will easily be transposed to the other plate support 18 and the other adapter plate 35 adjoining it.

It goes without saying that other means for fixing the adapter plate 34, 35 to its plate support 17, 18 may be provided. In the particular case in question, the distance from the plate 34, 35 to the plate support 17, 18 is adjusted by the width of the fixing clamps 37, 41.

As stated above, the adapter plates 34, 35 are not centred relative to their fixing plate support 17, 18. Each plate 34, 35 is offset rearwards relative to its fixing support 17, 18. Thus, the front edge of each plate 34, 35 is situated to the rear of the front vertical bar 20 of the support 17, 18, which explains the presence of two feet 39, 44 for fixing to the front bar, while the rear edge of each plate 34, 35 is situated to the rear of the rear vertical bar 19 of the support 17, 18, which explains that the fixing clamps 37, 41 do not extend as far as the rear end of the plate 34, 35, as seen above.

This offset is connected with the fact that the adapter plates 34, 35 must, in order to function optimally, extend in a centred fashion relative to the wall 4, 5 parallel to which they extend, that is, in a centred fashion relative to the cavity 2 of the oven 1. Thus, it can be seen in FIG. 3 that the plate 35 is centred relative to the wall 5 in front of which it extends. The microwaves are thus uniformly distributed in the cavity 2. The plate supports 18 are, for their part, used in the useful portion of the cavity 2, that is, the portion of the cavity empty of any equipment, free to receive plates. However, with reference to FIG. 3, the convection heating means 6 extend in front of the back wall of the cavity 2, separated from its useful volume, situated towards the front, by a protective wall 45 arranged to protect its convection heating means 6 while enabling hot air circulation. Thus the plate supports 17, 18 are centred on their supporting wall 4, 5 relative to this useful volume, that is, between the wall 45 for protecting the convection heating means 6 and the front opening of the cavity 2.

Operation of the oven 1 is completely conventional. Here it combines convection heating due to the means 6 adapted for this purpose, steam heating and microwave heating. The microwaves generated by the microwave-generating means 7 are agitated in the agitation enclosure 11, then emitted in the cavity 2 in which they are coupled, adapted, resonated, etc. in a known manner by the adapter plates 34, 35.

These adapter plates 34, 35 extend at a given distance from the side walls 4, 5 and are fixed to the plate supports 17, 18, themselves fixed both securely and removably to the side walls 4, 5.

If it is wished to clean the side walls 4, 5, the adapter plates 34, 35 and the plate supports 17, 18, it is very simple to dismount the plate supports 17, 18 from their means for fixing to the walls 4, 5 (here, by simple vertical lifting of a plate support 17, 18, its fixing means 3b, 31, 27 are disengaged from the corresponding fixing means 30′, 31′, 27′ of the wall 4, 5). The plate supports 17, 18 may then be taken out of the cavity 2 of the oven 1, the adapter plates 34, 35 being integral with them. It is then possible to wash directly the inner surfaces of the side walls 4, 5, the plate supports 17, 18 and the adapter plates 34, 35 being for example capable of being put in a suitable washing machine or cleaned by any other means.

It is preferable that the adapter plates 34, 35 are fixed integrally to their fixing plate support 17, 18, but it goes without saying that, if preferred, they may be fixed removably.

1. Microwave oven, comprising
a food-cooking cavity,
microwave-generating means,
at least one microwave adapter plate, and
at least one plate support mounted removably on a cavity wall,
wherein the microwave adapter plate is fixed to the plate support.

2. Microwave oven according to claim 1, in which the microwave adapter plate extends between the cavity wall and the plate support.

3. Microwave oven according to claim 1, in which the microwave adapter plate is welded to the plate support.

4. Microwave oven according to claim 3, in which,
the plate support comprising two vertical bars,
the microwave adapter plate is welded to the bars at the level of means for fixing to a plate top clamp and a plate bottom clamp.

5. Microwave oven according to claim 1, in which the microwave adapter plate is not centered relative to the plate support.

6. Microwave oven according to claim 4 in which, the microwave adapter plate being offset rearwardly from the plate support, the clamps of the microwave adapter plate are extended forwardly in two horizontal feet for fixing to one of the vertical bars of the plate support.

7. Microwave oven according to any of claim 1, in which the plate support comprises removable fixing means cooperating with dowels fixed to the cavity wall.

8. Microwave oven according to any of claim 1, comprising
two symmetrical microwave adapter plates and
two symmetrical plate supports;
each microwave adapter plate being fixed to a respective one of the plate supports.

9. Microwave oven according to claim 1, in which the microwave adapter plate comprises apertures.

10. Microwave oven according to claim 1, which is a so-called large-scale catering oven.

11. A microwave oven, the oven comprising:
a cavity;
a microwave generator;
a plate support removably mounted on a wall of the cavity; and
a microwave adapter plate fixed to the plate support.
